(19) United States
(12) Patent Application Publication
(10) Pub. No.: US 2013/0327900 A1
(43) Pub. Date: Dec. 12, 2013

(54) CABLE CATCHING DEVICE

(71) Applicant: Clifford Mark BURGIN, Collingham (GB)

(72) Inventor: Clifford Mark BURGIN, Collingham (GB)

(21) Appl. No.: 13/915,999

(22) Filed: Jun. 12, 2013

(30) Foreign Application Priority Data
Jun. 12, 2012 (GB) GB1210386.7

(51) Int. Cl. F16L 3/015

(52) U.S. Cl. CPC F16L 3/015
USPC 248/74.2

(57) ABSTRACT

A cable catching and retaining device is described, having a catching and retaining region in the form of a spiral. With introduction of a cable or wire having a connection and/or plug into the spiral region via the entrance to the spiral the connectors or plugs on the cables passing through the region are caught. The spiral cable catching and retaining region is made of wire and is integral with a region of the device in the form of a wire tension spring for securing the device to the edge of a table or work surface. The device may be manufactured using spring forming machines. The spiral region retains catches and retains cables passing through the region by preventing the connectors or plugs on the cables passing through the region.

### CROSS-REFERENCE TO RELATED APPLICATIONS

This application claims priority to Great Britain Patent Application No. GB1210386.7 filed Jun. 12, 2012, the disclosure of which is incorporated in its entirety by reference herein.

### FIELD OF INVENTION

The present invention is concerned with a cable catching device and more specifically with a cable catching device for use with tables, desks, desking systems, industrial applications and general cable management applications.

### BACKGROUND ART

In many environments work surfaces take the form of desks, tables or work stations. In the domestic setting there are increasing numbers of households that may have a specific location within the home for access to entertainment equipment such as TVs etc. The management of the various cables, cords, and wires found on or at a typical work surface or associated with home entertainment is an ongoing challenge. In the work and home environment almost all of the increasing number of available devices, including telephones, computers and their many peripheral devices, modems, routers, digital cameras, personal digital assistants (PDAs), notebooks and touch screen devices will be associated with at least one usually multiple wires or cables to transfer data through interconnection, receive power, and/or perform other functions e.g. printing or scanning. The increasing complexity of devices and their use means that in any one location there may be a large number of cables that may quickly become entangled and pose problems in the effective use of devices or simply result in a situation that is considered unsightly and unwieldy.

In the work or computer related environment The increase in the number of peripheral and other devices has lead to the introduction of connection hubs, which are units having multiple connection ports contained in a single housing. A universal serial bus (USB) hub, for example, allows a user to transform a single USB port into two, three, four, or more USB ports by plugging a cable attached to the USB hub into the single USB port, thereby activating the multiple USB ports of the USB hub. Such hubs are convenient and useful, but only add to the clutter, both because they introduce an additional cable and because the hub itself is another item that takes up space on the desktop and will often require its own power source.

The power for various devices can be directly from a wall mounted electrical or cable outlet or from a distribution board on the floor. Most common work surfaces or locations for entertainment equipment are often arranged with their rear edges contiguous with a wall or office partition. This make feeding cables from the work or entertainment surface rear difficult especially if the cables fall down the rear of the work surface.

In many situations there are more peripherals or devices located at a work surface or entertainment area than can be connected at any one time to a central device e.g. a computer or a TV or entertainment unit. This often means that many devices are disconnected for long periods of time and their connection cable, typically a USB cable, is left loose on the work or entertainment surface. This is problematic as it results in surface clutter and/or the connection cable is often lost behind or under a work or entertainment surface.

A number of approaches have been developed for securing and/or catching connection cables or power cables that may otherwise be lost behind work or entertainment surfaces. None of these have been found to be totally satisfactory. Accordingly, there exists a need for other forms of cable management and retention that are easy to implement increase the available connection options on a work surface or entertainment surface and help in preventing cable loss.

### DISCLOSURE OF THE INVENTION

Thus the present invention is a device that prevents cables and wires slipping from surfaces such as desks and tables and other raised surfaces and presents the connectors associated with such cables and wires ready for use when not connected.

Thus in accordance with the present invention there is provided a cable catching and retaining device comprising a catching and retaining region in the form of a spiral having means to introduce a cable or wire comprising a connection and/or plug means, to the spiral catching and retaining region such that the body of the cable effectively passes through the spiral region whilst passage of the connection and/or plug means through the spiral catching and retaining region is prevented.

In one embodiment the cable catching and retaining device is arranged so that it may be located within a conventional cable management conduit or grommet associated with a desking or workstation system or with computer or other networking systems.

In one embodiment the cable catching and retaining device is integral with a work surface or entertainment surface e.g. a desk or TV unit surface so as to provide a desk or domestic furniture unit with integral cable catching and retaining function.

In a further embodiment the cable catching and retaining device is arranged so that it is located within the body of housing of an electronic device. One example would be a computer housing or machinery housing in an industrial environment.

In a further embodiment the cable catching and retaining device is engineered into a wall or building product to provide integral cable catching and retaining device functionality within a building or office or factory or workplace.

In a preferred embodiment the cable catching and retaining device further comprises means to secure the device to the surface and/or edge of a work surface or entertainment surface or to the surface and/or edge of an electronic device or peripheral on a work surface or entertainment surface. Most preferably the device is adapted to be secured to the edge of a desk, workstation or entertainment unit.

In a preferred embodiment the spiral of the device is manufactured from a wire.

The spiral may also be referred to as a coil being a series of connected spirals or concentric rings formed by a material through gathering or winding.

In a preferred embodiment the whole device is manufactured from wire and the spiral is integral with the means to secure the device to the surface and/or edge of a work surface or entertainment surface or to the surface and/or edge of an electronic device or peripheral on a work surface or entertainment surface.

It is preferred that the securing means takes the form or a sprung wire clip comprising one region for contact with a surface of a work surface or entertainment surface or an electronic device or peripheral and a second region for contact with a different surface of the work surface or entertainment surface or electronic device or peripheral. Preferably the securing means is provided by a tension or extension spring effect.

It is preferred that when the securing means is in the form of an integral wire that the region of contact proximate to the spiral region has a tortuous path providing a platform. One form of tortuous path is a zig-zag pattern of the part of the device that rests on top of the desk or surface. This provides additional friction to stop the cable dragging the device off the edge by presenting more wire in contact with the surface of the desk. It also provides greater stability to stop the device tipping sideways.

When in integral wire form the device of the present invention may be manufactured using any conventional 3D spring forming machine such as a CNC spring or wire forming machine.

The device of the present invention may be manufactured from any suitable material but is preferably manufactured from wire typically used in the manufacture of tension or extension springs.

The spiral may take the form of an Archimedean spiral, a hyperbolic or reciprocal spiral, a logarithmic spiral, a Fermat's spiral or any form of similar spiral in-between these spiral shapes. The spiral where possible may also be in the form of a conical spiral. With certain spiral forms such as the hyperbolic form the arms of the spiral become ever closer to each other as one approaches the centre of the spiral. In devices with this form of spiral or similar any cable located within and passing through the body of the spiral may actually become clamped and secured between adjacent arms of the spiral if desired. In other forms of spiral such as the Archimedean spiral the arms of the spiral remain equidistant as one moves from the edge to the centre of the spiral and no clamping effect is observed. The spiral may not be symmetrical or of a conventional form, it may simply be the arrangement of a single wire or material in a tortuous path in a single plane or multiple planes or as a cone defining a gap between adjacent parts of the wire that may accommodate the body of a cable, whilst ensuring the connectors and/or power sockets on the cable may not pass through the same gap. Thus the spiral may be square or rectangular in shape or may be completely unsymmetrical with the arms of the spiral region forming a tortuous path through the spiral. In free form spiral arrangements the final spiral shape and structure may be arranged as recognizable objects e.g. a flower or a cats or dogs face etc. The gaps between adjacent arms of the spiral or continuous wire may be the same or variable throughout the path defined by the spiral or continuous wire.

In a further embodiment the device may be manufactured from plastic such as injection molded plastic and the securing means may also be plastic and integral with the spiral.

The means to introduce a cable or wire comprising a connection and/or plug means to the spiral preferably takes the form of an opening at the start (entrance to) or at the terminus of the spiral. When at the start this entrance is located at the edge of the spiral and is arranged such that when the device is secured to a surface it is easily accessible. When at the terminus of the spiral this is typically located at the centre of the spiral and may take the form of a widening of the spiral at that location to allow the cable to be removed or may take the form or a void at the centre of the spiral and into which the cable can pass and which allows removal of the cable.

The device of the present invention can accommodate more than one cable or wire at a time and can simultaneously accommodate cables and wires of different thicknesses.

The arrangement of the device may be such that whilst located at the edge region of a desk or surface the spiral is not visible on the desk surface or from a normal perusal of the desk surface. In this embodiment the securing means is designed to locate the spiral out of view of the desk user. Thus the securing means may be in the form of a screw and the spiral may be adapted to be secure via a screw or similar attachment means to the underside or side of a desk or unit to provide hidden cable catching and retaining function.

The dimensions of the spiral may be selected to accommodate specific types of cable with connectors, thus the device of the present invention may have spiral dimensions to accommodate and retain the cables for one or more devices or peripherals selected from telephones, computers and their many peripheral devices, modems, routers, digital cameras, personal digital assistants (PDAs), notebooks and touch screen devices and mobile phone charging leads.

### BRIEF DESCRIPTION OF THE DRAWINGS

The invention will be better understood from a reading of the following detailed description, taken in conjunction with the accompanying figures in the drawings in which:

FIG. 1(a) to (g) show examples of various forms of spiral arrangement for use in the present invention;

FIG. 2 is a perspective view of a preferred device of the present invention;

FIG. 3 is a perspective front view of a preferred device of the present invention;

FIG. 4 is a perspective back view of a preferred device of the present invention;

FIG. 5 is a perspective top view of a preferred device of the present invention;

FIG. 6 is a perspective bottom view of a preferred device of the present invention; and

FIG. 7 is a perspective side view of a preferred device of the present invention;

### DETAILED DESCRIPTION

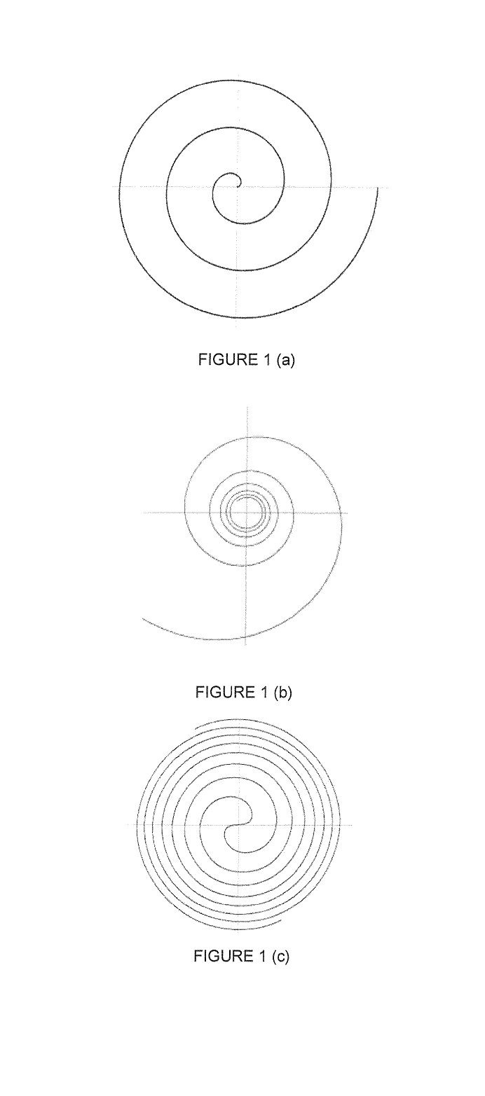

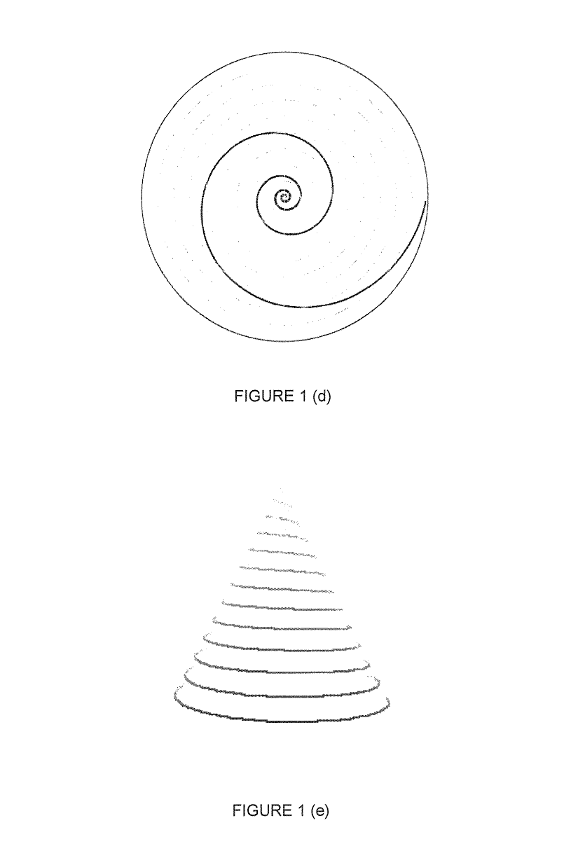

With reference to FIGS. 1(a) to (g) various forms of spiral arrangement are shown that may be suitable for use in the present invention. These include an Archimedes spiral (1(a)), a hyperbolic spiral (1(b)), a Fermat's spiral (a(c)), a logarithmic spiral (1(d)), a conical spiral (1(e)), a square spiral (1(f)) and a tortuous asymmetrical spiral (1(g)).

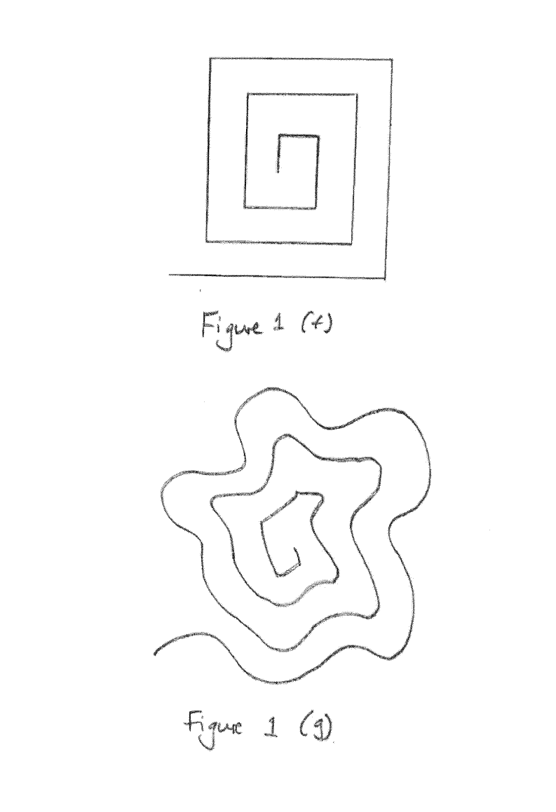

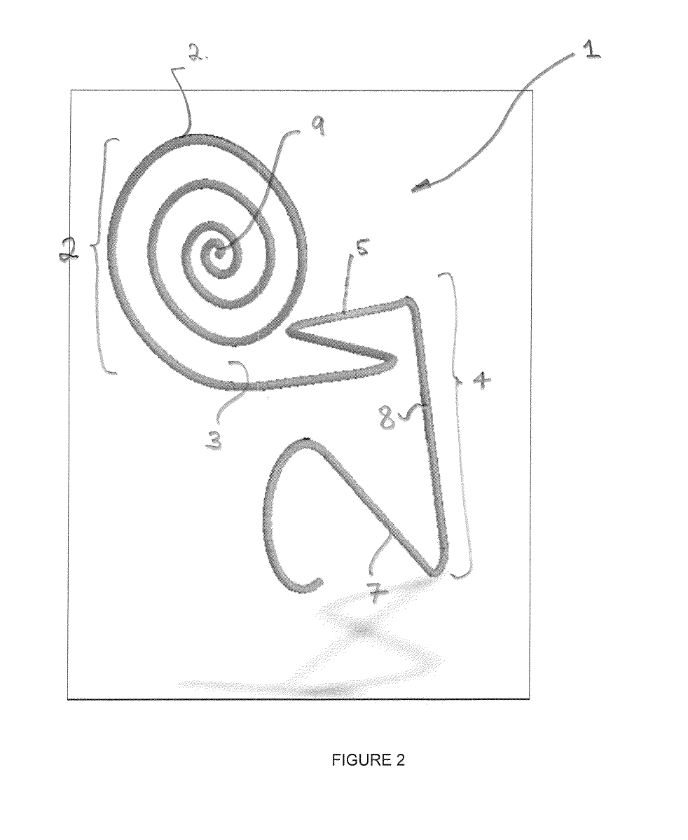

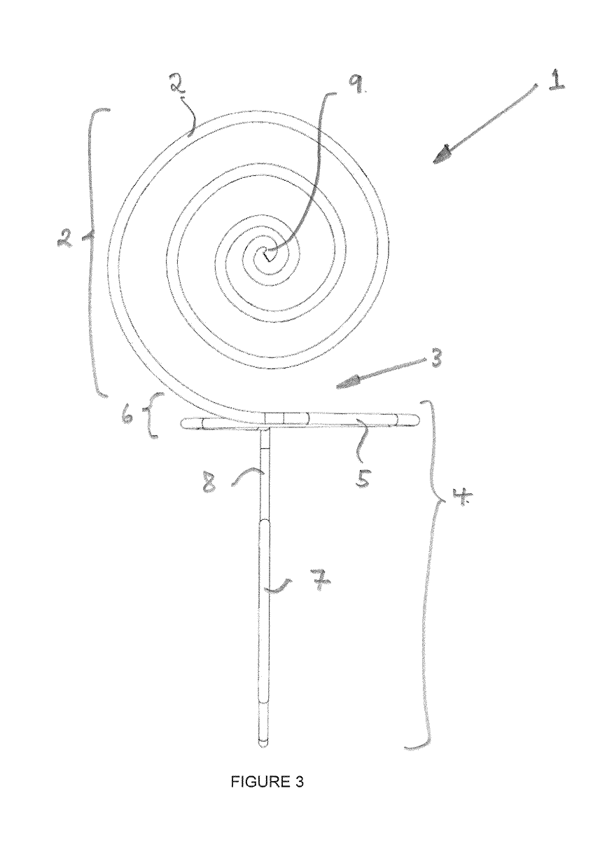

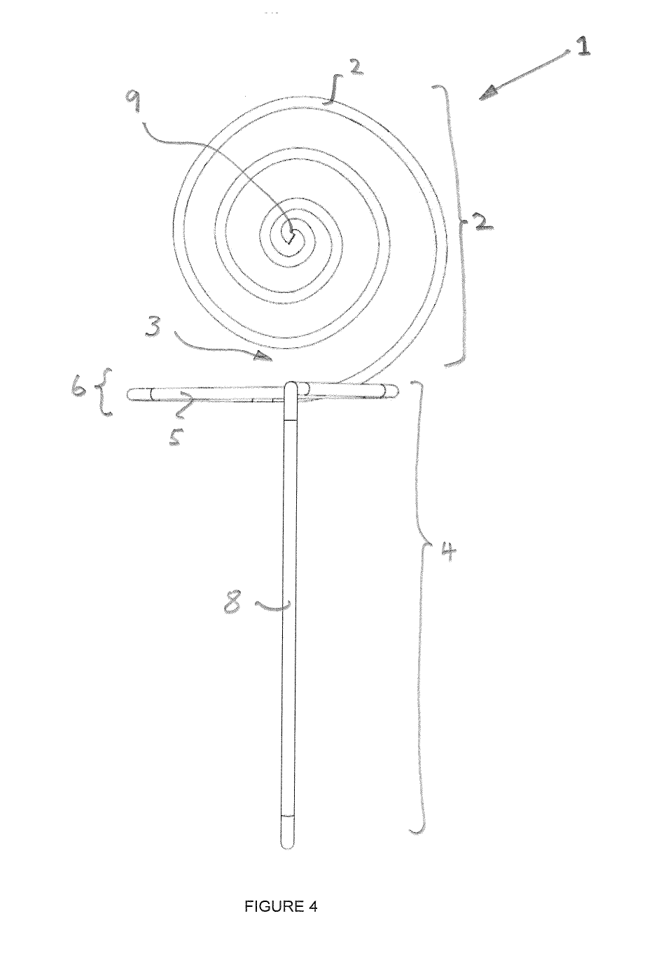

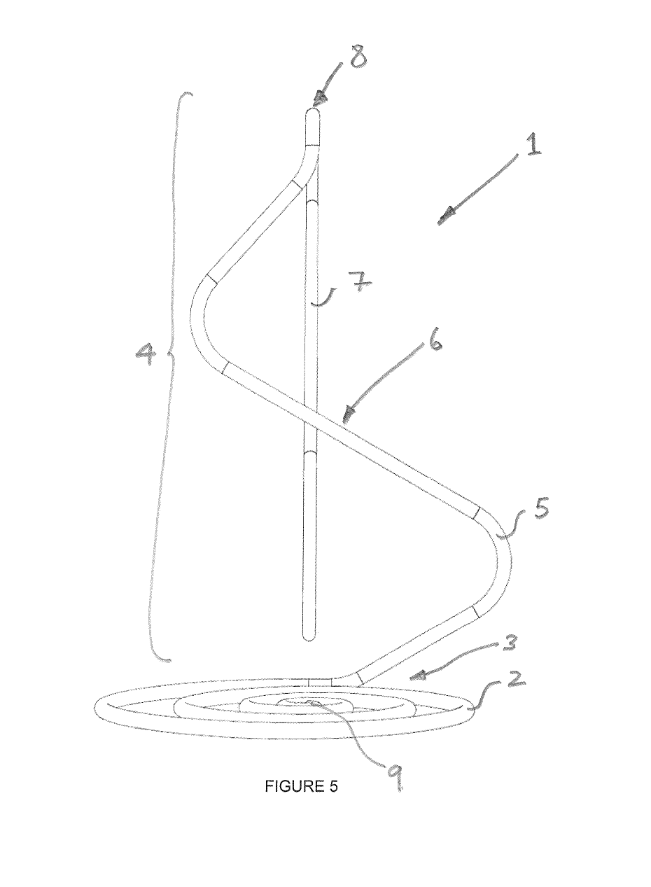

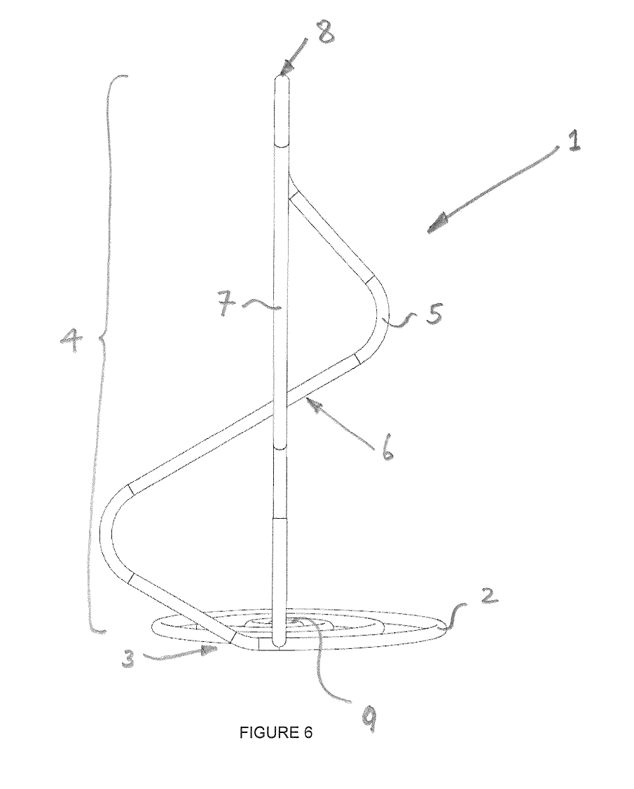

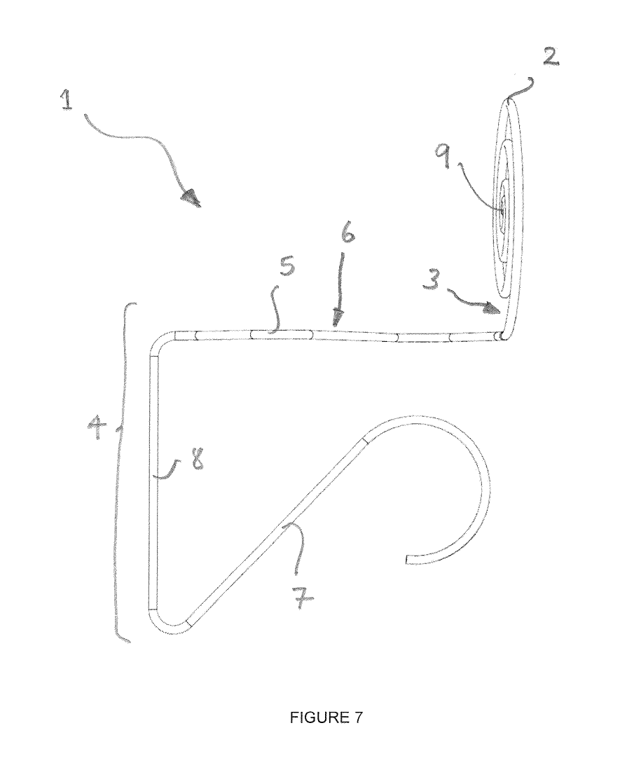

With reference to FIGS. 2 to 7 a cable catching and retaining device (1) is shown comprising a catching and retaining region in the form of a wire spiral (2) having means (3) to introduce a cable or wire comprising a connection and/or plug means, to the spiral catching and retaining region (2) such that the body of the cable effectively passes through the spiral region (2) whilst passage of the connection and/or plug means through the spiral catching and retaining region (2) is prevented. The device (1) is manufactured from a spring wire and the spiral (2) continues to form a means (4) to secure the device (1) to the edge and surface of a desk. The securing means (4) is integral with the spiral (2) and is in the form of a tension spring. The section (5) proximate to the spiral (2) and cable introduction means (3) is in the form of a zig-zag section of wire. This zig-zag region effectively forms a platform region (6) to the top surface of the tension spring (4), which is in contact with the top of the desk. aids the spring action and also enhances stability of the device (1) when secured to the edge and surface of a desk. The lower part (7) of the tension spring (4) is located beneath the desk surface and connected via section (8) to the platform region (6). In use the device (1) is secured to a desk edge by means of the tension spring section (4) such that the spiral (2) entrance (3) and platform (6) are on the top surface of the desk. The cable body is then passed through the entrance (3) and into the body of the spiral section (2). At this point the cable body may be able to freely move within the spiral (2) as the cable body is pushed further into the spiral body (2) towards the terminus (9) the adjacent sections of the spiral body (2) come closer together and eventually the cable engages with the spiral body (2) such that it is tightly gripped by the spiral body (2). The dimensions of the spiral body (2) are such that the connections or plugs on the cable are not able to pass through the spiral body (2).

1. A cable catching and retaining device comprising a catching and retaining region in the form of a spiral having means to introduce a cable or wire comprising a connection and/or plug means, to the spiral catching and retaining region such that the body of the cable effectively passes through the spiral region whilst passage of the connection and/or plug means through the spiral catching and retaining region is prevented.

2. The device as claimed in claim 1 wherein the cable catching and retaining device is arranged so that it may be located within a conventional cable management conduit or grommet associated with a desking or workstation system or with computer or other networking systems.

3. The device as claimed in claim 1 wherein the cable catching and retaining device is integral with a work surface or entertainment surface so as to provide a desk or domestic furniture unit with integral cable catching and retaining function.

4. The device as claimed in claim 1 wherein the cable catching and retaining device is arranged so that it is located within the body of housing of an electronic device.

5. The device as claimed in claim 1 adapted to be incorporated within a wall or building product to provide integral cable catching and retaining device functionality within a building or office or factory or workplace built using the building product.

6. The device as claimed in claim 1 further comprising means to secure the device to the surface and/or edge of a work surface or entertainment surface or to the surface and/or edge of an electronic device or peripheral on a work surface or entertainment surface.

7. The device as claimed in claim 6 wherein the device is adapted to be secured to the edge of a desk, workstation or entertainment unit.

8. The device as claimed in claim 1 wherein the spiral of the device is manufactured from a wire.

9. The device as claimed in claim 1 wherein the spiral is a coil being a series of connected spirals or concentric rings formed by a material through gathering or winding.

10. The device as claimed in claim 1 wherein the whole device is manufactured from wire and the spiral is integral with the means to secure the device to the surface and/or edge of a work surface or entertainment surface or to the surface and/or edge of an electronic device or peripheral on a work surface or entertainment surface.

11. The device as claimed in claim 1 wherein the securing means takes the form or a sprung wire clip comprising one region for contact with a surface of a work surface or entertainment surface or an electronic device or peripheral and a second region for contact with a different surface of the work surface or entertainment surface or electronic device or peripheral.

12. The device as claimed in claim 11 wherein the securing means is provided by a tension or extension spring effect.

13. The device as claimed in claim 11 wherein the securing means is in the form of an integral wire and the region of contact proximate to the spiral region has a tortuous path providing a platform.

14. The device as claimed in claim 13 wherein the form of tortuous path is a zig-zag pattern of the part of the device that rests on top of the desk or surface.

15. The device as claimed in claim 1 wherein the spiral is in the form of an Archimedean spiral or a hyperbolic or reciprocal spiral or a logarithmic spiral or a Fermat's spiral or any intermediate form of similar spiral in-between these spiral types.

16. The device as claimed in claim 1 wherein the spiral is in the form of a conical spiral.

17. The device as claimed in claim 1 wherein the form and dimensions of the spiral are such that the spiral may clamp the cable body on insertion into the spiral body.

18. The device as claimed in claim 1 wherein the spiral body is square or rectangular or unsymmetrical in shape.

19. The device as claimed in claim 1 wherein the spiral dimensions are selected to accommodate and retain the cables for one or more devices or peripherals selected from telephones, computers and their many peripheral devices, modems, routers, digital cameras, personal digital assistants (PDAs), notebooks and touch screen devices and mobile phone charging leads.
